(19) United States
(12) Patent Application Publication
(10) Pub. No.: US 2006/0057292 A1
(43) Pub. Date: Mar. 16, 2006

(54) Process for producing oxygen partial pressure detecting part of resistance oxygen sensor

(75) Inventors: Noriya Izu, Aichi (JP); Woosuck Shin, Aichi (JP); Ichiro Matsubara, Aichi (JP); Norimitsu Murayama, Aichi (JP); Yukihiko Yamauchi, Aichi (JP); Shuzo Kanzaki, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Institute of Adv. Industrial Sci. & Tech, Tokyo (JP)

(21) Appl. No.: 10/540,873

(22) PCT Filed: Dec. 22, 2003
(86) PCT No.: PCT/JP03/16469

§ 371 Date: Jun. 27, 2005

(30) Foreign Application Priority Data
Dec. 25, 2002 (JP) 2002373455

(51) Int. Cl. B05D 3/02; C08J 7/04

(52) U.S. Cl. 427/372.2; 338/36; 427/504

(57) ABSTRACT

The present invention provides a method of manufacturing a porous thick film of an oxide that has extremely few cracks and can be satisfactorily used as an oxygen partial pressure detecting part of an oxygen sensor. The present invention relates to a method of manufacturing such a porous thick film as an oxygen partial pressure detecting part of a resistive oxygen sensor comprising taking a fine particle powder of an oxide containing cerium oxide as a raw material powder, preparing a paste containing the oxide, printing the paste onto a substrate by screen printing, calcining and sintering, the method comprising a step of carrying out heat treatment to effect particle growth from the average particle diameter of the raw material powder to a particle diameter less than the average particle diameter of the ultimately obtained thick film, a step of mixing the particle growth-effected powder with a solvent, a step of dispersing agglomerated particles in the solvent, a step of removing a precipitate, a step of evaporating off the solvent, and a step of mixing the resulting oxide with an organic binder to obtain the paste.

### BACKGROUND OF THE INVENTION

1. Field of the Invention

The present invention relates to a method of manufacturing a porous thick film to be used in an oxygen partial pressure detecting part of a resistive oxygen sensor, and more specifically relates to a cerium oxide-based porous thick film as an oxygen partial pressure detecting part of an oxygen sensor that measures oxygen partial pressure and is used in an air-fuel ratio feedback control system for controlling the air-fuel ratio in the exhaust gas of an automobile or the like, so as to improve the exhaust gas purification rate and the fuel efficiency, and a method of manufacturing the cerium oxide-based porous thick film. Here, the air-fuel ratio is the ratio of air to fuel, there being a one-to-one relationship between the oxygen partial pressure and the air-fuel ratio.

2. Description of the Related Art

Hitherto, as oxygen gas sensors for automobiles and the like, solid electrolyte ones have predominantly been used (see, for example, Japanese Patent Application Laid-open No. S55-137334/1980). With this type of sensor, the difference in the oxygen partial pressure between a reference electrode and a measuring electrode is measured as an electromotive force, and hence a reference electrode is required; there has thus been a problem that the structure is complex, and it is difficult to make the sensor small. To overcome this problem, resistive oxygen gas sensors that do not require a reference electrode have been developed (see, for example, Japanese Patent Application Laid-open No. S62-174644/1987). Briefly explaining the measurement principle of such a resistive oxygen gas sensor, first when the oxygen partial pressure of the ambient environment changes, the oxygen vacancy concentration in an oxide semiconductor changes. There is a one-to-one relationship between the resistivity or electrical conductivity of the oxide semiconductor and the oxygen vacancy concentration, the resistivity of the oxide semiconductor changing as the oxygen vacancy concentration changes. By measuring the resistivity, the oxygen partial pressure of the ambient environment can thus be determined.

However, with such a resistive oxygen gas sensor, there has been a problem that the responsiveness of the output upon the oxygen partial pressure changing is poor (see, for example, Japanese Patent Application Laid-open No. H07-63719/1995). Moreover, titanium oxide has been used as the oxide semiconductor of resistive oxygen gas sensors, but this material has had the problem of being poor in terms of durability and stability. To overcome these problems, the present inventors have carried out research and development into resistive oxygen gas sensors that use cerium oxide, the reason being that cerium oxide is durable in corrosive gases (see E. B. Varhegyietal., Sensors and Actuator B, 18-19 (1994) 569). Through this research and development, the present inventors have discovered that with a resistive oxygen sensor using cerium oxide, the response speed can be improved by making the average particle diameter of the cerium oxide be as small as 200 nm and also be adding zirconium oxide to the cerium oxide, and have previously filed a patent application regarding this.

With the above inventions, a thick film is preferable as the form of the oxygen partial pressure detecting part, and to improve the response speed, the particle diameter of this thick film must be made low. A method of manufacturing such a thick film is as follows. A powder comprising fine particles of an oxide is first taken as a raw material, a paste containing this raw material is prepared, this paste is applied onto substrate by screen printing, and sintering is carried out, whereby a porous thick film as an oxygen partial pressure detecting part of a resistive oxygen sensor is manufactured. Here, the operating temperature of the oxygen sensor will reach 1000° C. as a maximum. The screen-printed article must thus be sintered at a temperature exceeding 1000° C. in advance so that particle growth will not occur at temperatures up to 1000° C.

With the above inventions, the raw material powder has been prepared using a spray pyrolysis method. With this method, regarding the properties of the fine particles, agglomeration is not prone to occurring, and moreover the fine particles of the raw material powder have a relatively high particle diameter (at least approximately 40 nm); it has thus been possible to obtain a porous thick film having extremely few cracks merely by preparing a paste using this raw material powder and screen printing. However, with the spray pyrolysis method, there has been a problem that the amount of powder manufactured per unit time is low. On the other hand, fine particles of cerium oxide or an oxide having cerium oxide as a principal component thereof can be obtained using another method (see Japanese Patent Application Laid-open No. 2002-255515/2002). This methodhas as the primary objective thereof obtaining extremely fine particles, and is a method enabling mass production, and hence can be said to be better than the spray pyrolysis method from an industrial standpoint. However, a powder obtained using this method is extremely fine, and moreover the fine particles are agglomerated; in the case of manufacturing a porous thick film from a paste in which such a powder and a vehicle (organic binder) are merely mixed together, there is thus a problem that there are many cracks, and hence the resistance of the thick film increases. It is undesirable for the resistance to increase, since then the measuring circuitry for measuring the resistance becomes complex. Moreover, there is a problem that in the case that the cracks are very severe, there is no electrical conductivity, and hence use as an oxygen sensor is not possible, and moreover there has also been a problem that the thick film readily peels away from the substrate because of the cracks.

### SUMMARY OF THE INVENTION

In view of the prior art described above, it is an object of the present invention to thoroughly resolve the problems thereof, and provide a porous thick film of cerium oxide or an oxide having cerium oxide as a principal component thereof that has extremely few cracks and can be satisfactorily used as an oxygen partial pressure detecting part of an oxygen sensor, and a method of manufacturing such a porous thick film. Moreover, ideally, it is an object of the present invention to provide a method of manufacturing a porous thick film having an average particle diameter of not more than 200 nm.

To attain the above objects, the present invention is constituted from the following technical means.

(1) A method of manufacturing a porous thick film as an oxygen partial pressure detecting part of a resistive oxygen sensor comprising taking a fine particle powder of an oxide containing cerium oxide as a raw material powder, preparing a paste containing the oxide, printing the paste onto a substrate by screen printing, calcining and sintering, the method comprising: a heat treatment step of carrying out heat treatment to effect particle growth from the average particle diameter of the raw material powder to a particle diameter less than the average particle diameter of the ultimately obtained thick film; a step of mixing the particle growth-effected powder with a solvent; a step of dispersing agglomerated particles in the solvent; a step of removing a precipitate; a step of evaporating off the solvent; and a step of mixing the resulting oxide with an organic binder to obtain the paste.

(2) The method according to (1) above, wherein the average particle diameter of the porous thick film is not more than 200 nm.

(3) The method according to (1) above, wherein the average particle diameter of the particle growth-effected powder obtained through the heat treatment step is at least 45 nm.

(4) The method according to (1) above, wherein the average particle diameter of the raw material powder before the heat treatment step is at least 10 nm but less than 45 nm.

(5) The method according to (1) above, wherein the raw material powder is subjected to heat treatment at 880° C. to 920° C. in the heat treatment step.

(6) The method according to (1) above, wherein the proportion by weight of the oxide in the paste is adjusted to 10 to 30 wt %.

(7) The method according to (1) above, wherein the fine particle powder of an oxide containing cerium oxide is a fine particle powder of an oxide containing cerium oxide and zirconium oxide.

(8) A cerium oxide-based porous thick film as an oxygen partial pressure detecting part of a resistive oxygen sensor, the porous thick film manufactured using the method according to any of (1) through (7) above, whereby the porous thick film has few cracks, has an average particle diameter of not more than 200 nm, and has an electrical conductivity of at least 10⁻³ S/m at 800° C.

Next, the present invention will be described in more detail.

A flowchart of a manufacturing method of the present invention is shown in FIG. 1. In the present invention, cerium oxide, or an oxide having cerium oxide as a principal component thereof is used as a raw material. Specifically, an ‘oxide having cerium oxide as a principal component thereof’ is, for example, an oxide having cerium oxide as a principal component thereof and containing zirconium oxide, titanium oxide, germanium oxide, hafnium oxide or the like, more preferably an oxide having cerium oxide as a principal component thereof and containing zirconium oxide. In the case that the secondary component is more abundant than the cerium oxide, the properties of the powder will be greatly different to those of cerium oxide, and hence it is preferable for the secondary component concentration to be not more than 40 mol %. Moreover, the fine particles of the raw material preferably have an average particle diameter of 10 to 20 nm, with it being acceptable for there to be a spread of particle diameters. The method of the present invention can be suitably applied to a powder of an oxide as described above comprising fine particles having a low particle diameter (less than 40 nm) that readily agglomerate. Examples of methods of manufacturing such oxide fine particles include, for example, a precipitation method, a coprecipitation method, and a hydrothermal synthesis method. With the precipitation method or coprecipitation method, a precipitate containing a hydroxide, water and so on is heated in air, whereby an oxide powder can be obtained. In the case of cerium oxide, the oxide can be obtained upon heating at a temperature of 600° C. The heat treatment step for changing the precipitate containing the hydroxide, water and so on into the oxide, and a heat treatment step for effecting particle growth of the present invention can thus be carried out consecutively.

With the present invention, first, to effect particle growth to a particle diameter less than the average particle diameter of the thick film to be ultimately obtained, a raw material powder as described above is subjected to heat treatment in a heat treatment step; this is because if particle growth is not effected, then cracks will arise in the thick film after the sintering step described later (see Example 1 and Comparative Example 2). Moreover, the reason for making the particle diameter to which the particle growth is effected be less than the average particle diameter of the thick film to be ultimately obtained is that it is not possible to reduce the particle diameter in the final sintering step. The temperature in the heat treatment step is preferably at least 800° C., this being because at a lower temperature particle growth will not occur. Furthermore, in the case that the average particle diameter of the thick film ultimately obtained is made to be, for example, 100 nm, the temperature in the heat treatment step is preferably 880 to 920° C. This is because with sintering at approximately 950° C. or more, particle growth will occur to a particle diameter exceeding 100 nm (see Example 2), and hence it will be impossible to make the average particle diameter of the thick film ultimately obtained be not more than 100 nm.

In general, the temperature in the heat treatment of the powder is set to be lower than the sintering temperature in the sintering carried out after the screen printing. Consequently, in the case of making the average particle diameter of the thick film ultimately obtained be, for example, 100 nm, it is sufficient if the particle diameter to which the particle growth is effected in the heat treatment step is at least 45 nm. As shown in Example 1 described later, in the case that the average particle diameter of the particle growth-effected powder is 48nm, a porous thick film having extremely few cracks is obtained. It is obvious that even in the case of a particle diameter higher that this, a porous thick film having no cracks can be obtained, and hence if the particle diameter to which the particle growth is effected in the heat treatment step is at least 45 nm, then a porous thick film having extremely few cracks can be obtained. Next, a solvent is added to the raw material oxide; the solvent is preferably an organic solvent that has a low viscosity and is easily evaporated such as ethanol or toluene. This is because a solvent that can be easily evaporated in the subsequent step of reducing the amount of the solvent is preferable. Next, the oxide is treated in the solvent using an ultrasonic homogenizer or the like, thus dispersing agglomerated particles. A powder obtained by the precipitation method or coprecipitation method is characterized in that the fine particles are agglomerated. If the powder is made into a paste while the particles are still agglomerated, then the thick film ultimately obtained will be extremely bumpy, and hence will not readily stick to an electrode or the like. Moreover, agglomerated particles are a cause of cracks arising. It is thus necessary to disperse agglomerated particles. Moreover, even if the particles were not agglomerated before the heat treatment, the particles will agglomerate through the heat treatment in the heat treatment step described above, and hence this dispersion step is always required.

Next, the solvent containing the oxide is left to stand as is, and after, for example, approximately 30 to 40 minutes, precipitate is removed. The precipitate comprises still agglomerated particles, and precipitates out through its own weight, and can thus be separated from the dispersed particles. Next, the solvent is evaporated off while heating and while stirring. After that, an organic binder is added; an example of an organic binder is a vehicle comprising a mixture of ethyl cellulose and terpineol, but there is no limitation to this. The organic binder is a liquid having a prescribed viscosity, and by adding this a paste of a viscosity enabling screen printing is obtained. In the current step, the wt % of the oxide is adjusted to a prescribed value, whereby an oxide-containing paste is obtained. The wt % of the oxide is, for example, preferably 10 to 30 wt %. This is because it is thought that if the proportion of the oxide in the paste is too high, then the mixing will be uneven. Moreover, if this proportion is too low, then the amount used of the binder will be high, which will be wasteful.

Next, the paste is printed onto a substrate by screen printing. Here, an insulating material is used for the substrate. Preferable examples include alumina, magnesia and quartz, but there is no limitation thereto. Next, calcination is carried out at 300 to 600° C., thus removing the organic binder. As the calcination atmosphere, air, or an oxidizing atmosphere such as oxygen is preferable. This step can be omitted in the case that the rate of temperature increase in the subsequent sintering step is set to be gradual. Finally, sintering is carried out at 1000 to 1200° C., whereby an oxygen partial pressure detecting part of a resistive oxygen sensor is obtained. The sintering atmosphere may be any of air, an oxidizing atmosphere such as or oxygen, or a reducing atmosphere such as hydrogen or carbon monoxide. Through the sintering, necks are produced between the fine particles to form a porous body, which is electrically conductive. The average particle diameter preferably becomes 50 to 200 nm, more preferably 50 to 100 nm. The porous thick film obtained through the above manufacturing method has extremely few cracks, and can be satisfactorily used as an oxygen partial pressure detecting part of an oxygen sensor; specifically, the electrical conductivity is at least 10⁻³ S/m at 800° C., an excellent oxygen partial pressure dependence is exhibited, and the response speed is also excellent.

In the heat treatment step described earlier, the particle diameter of the powder is made to grow through the heat treatment; as described earlier, if such particle growth is not effected, then particle growth will occur in the subsequent sintering stage, and volume shrinkage will occur accompanying this. At this time, stress must be relaxed, and it is thought that this is why cracks arise in the thick film. Alternatively, it is thought that this may be because the particle diameter is low, and hence the mixing with the organic binder becomes uneven, whereby places where the fine particles are abundant and places where the fine particles are sparse arise. In any case, to prevent such cracking, it is necessary to effect particle growth in advance. Next, in the step of dispersing agglomerated particles described earlier, particles that have agglomerated in the solvent are dispersed; in the case that the particle diameter of the fine particles is low, even in the case of particles having no agglomeration at the raw material stage, agglomeration arises upon effecting particle growth in the heat treatment step, and hence this dispersion step is required.

Particles that are still agglomerated after this step can be removed as a precipitate in the step of removing the precipitate described earlier. Note that one can also envisage loosening the agglomeration through a mechanical method such as pulverization, but cerium oxide is also used as a polishing agent, and hence upon mechanical pulverization, impurities will be expected to get in; a mechanical method such as pulverization therefore cannot be used. In the step of preparing the paste, if the wt % of the oxide is too high, then the proportion of the oxide out of the whole will be high, in which case the mixing between the organic binder and the oxide will be uneven, and hence cracks and so on will become prone to occurring. Moreover, if the wt % is too low, then the proportion of the oxide in the paste will be low, and hence a large amount of the paste will be required, which will be wasteful. The wt % of the oxide is thus preferably 10 to 30 wt %.

### BRIEF DESCRIPTION OF THE DRAWINGS

FIG. 1 shows a flowchart of a method of the present invention;

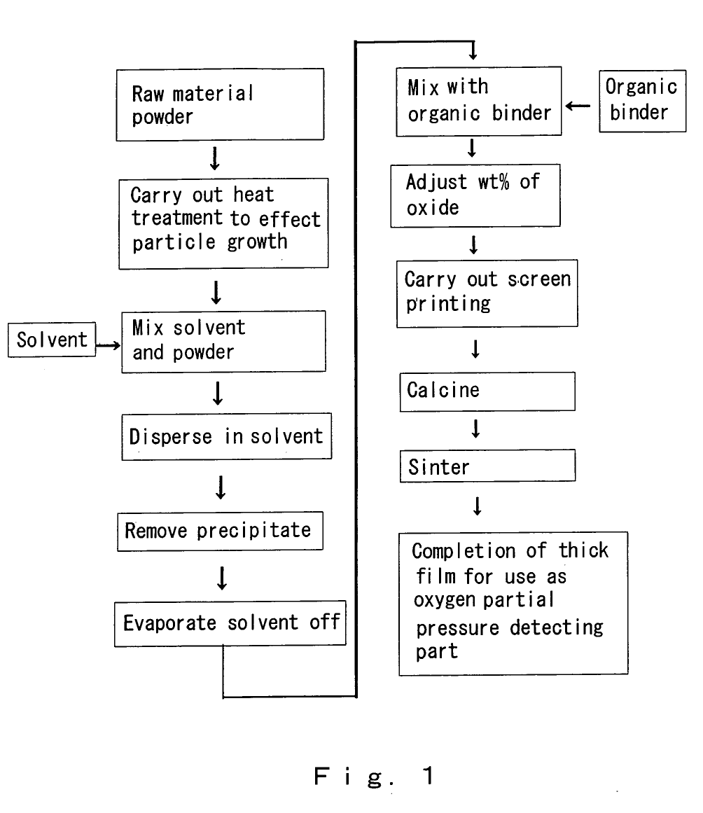

FIG. 2 shows a scanning electron microscope (SEM) photomicrograph of a raw material powder comprising cerium oxide fine particles obtained through a precipitation method before a heat treatment step as pretreatment in Example 1;

FIG. 3 shows a low-magnification SEM photomicrograph of the raw material powder comprising cerium oxide fine particles obtained through the precipitation method before the heat treatment step as pretreatment in Example 1;

FIG. 4 shows an SEM photomicrograph of the raw material powder after the heat treatment step as pretreatment in Example 1;

FIG. 5 shows an SEM photomicrograph of a thick film manufactured using a paste in which the oxide wt % is 50 wt % in Example 1;

FIG. 6 shows an SEM photomicrograph of a thick film manufactured using a paste in which the oxide wt % is 30 wt % in Example 1;

FIG. 7 shows an SEM photomicrograph of a thick film manufactured using a paste in which the oxide wt % is 20 wt % in Example 1;

FIG. 8 shows an SEM photomicrograph of a thick film manufactured using a paste in which the oxide wt % is 10 wt % in Example 1;

FIG. 9 shows a high-magnification SEM photomicrograph of the thick film manufactured using the paste in which the oxide wt % is 30 wt % in Example 1;

FIG. 10 shows an SEM photomicrograph of a thick film obtained by sintering at 1100° C. in Comparative Example 1;

FIG. 11 shows a high-magnification SEM photomicrograph of a thick film manufactured using a paste in which the oxide wt % is 30 wt % in Comparative Example 2; and

FIG. 12 shows an SEM photomicrograph of a powder for the case that a powder comprising cerium oxide fine particles obtained using a precipitation method was taken as a raw material and the pretreatment temperature was made to be 950° C. in Example 2.

### DESCRIPTION OF THE PREFERRED EMBODIMENTS

Next, the present invention will be described concretely through examples; however, the present invention is not limited by the following examples whatsoever.

### EXAMPLE 1

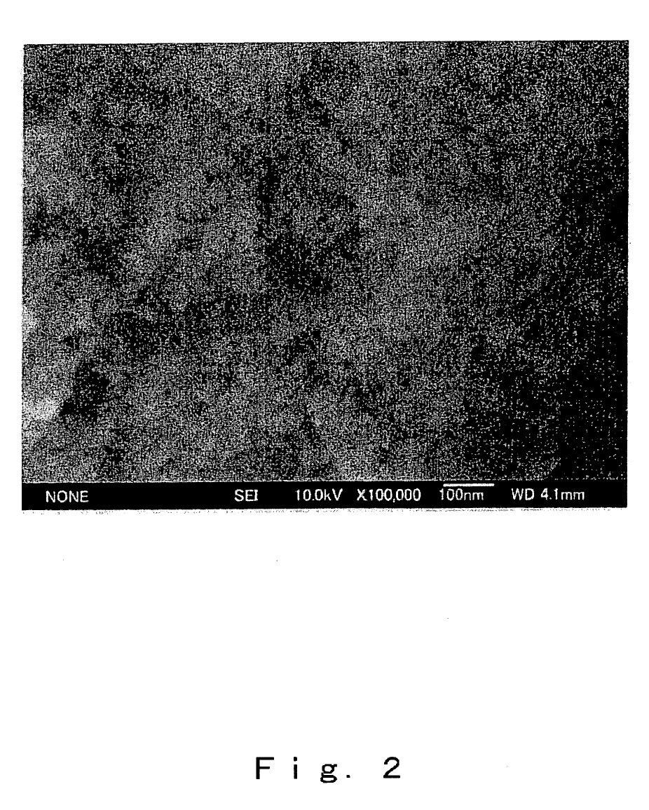

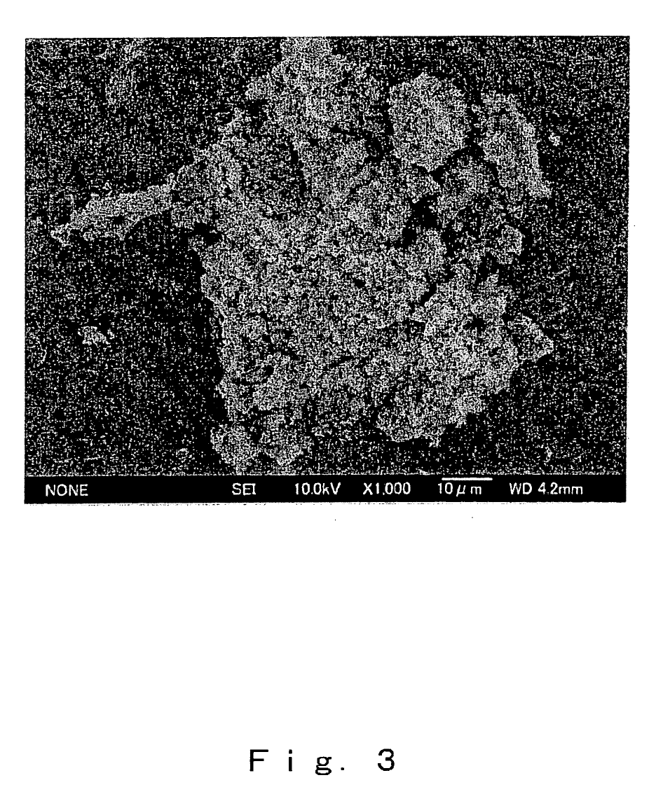

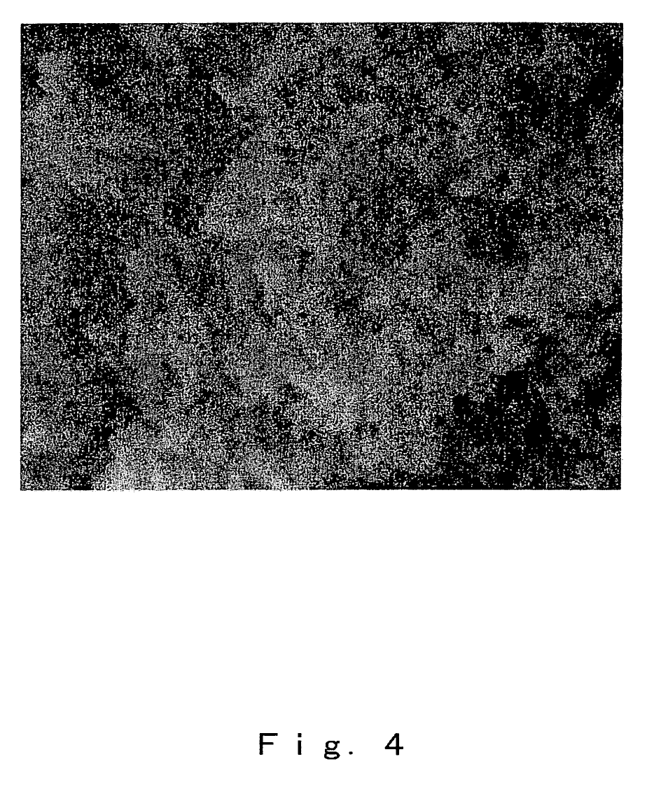

In the present example, a powder comprising cerium oxide fine particles obtained through a precipitation method was used as a raw material. Briefly describing the method of preparing the powder using the precipitation method, first a cerium nitrate aqueous solution was prepared. Next, ammonia water was added, whereby a precipitate was produced. This precipitate was mixed with carbon, and heated for 4 hours at 600° C. in air, thus obtaining the powder. Scanning electron microscope (SEM) photomicrographs of the powder (the raw material before the heat treatment step) are shown in FIGS. 2 and 3. The raw material had a particle diameter of 10 to 20 nm, and was agglomerated. Next, as a pretreatment step, the powder was subjected to heat treatment for 4 hours at 900° C. in air. An SEM photomicrograph of the raw material after this step is shown in FIG. 4. Particle growth occurred, the average particle diameter becoming 48 nm.

Next, ethanol was added as a solvent in a proportion of 50 ml per 1 g of the raw material. Dispersion was then carried out for 10 minutes using an ultrasonic homogenizer. After the dispersion, the ethanol containing the raw material was left to stand for 40 minutes, and then the still agglomerated precipitate was removed. Ethanol was then again added so that the volume of the ethanol containing the raw material became 50 ml, and then dispersion was again carried out for a further 10 minutes using an ultrasonic homogenizer. After the dispersion, the ethanol containing the raw material was left to stand for 30 minutes, and then the precipitate was removed. At this stage, the weight of still agglomerated precipitate removed was 0.3 to 0.5 g per 1 g of the raw material initially used.

Next, the ethanol containing the oxide was heated to approximately 60° C. while stirring with a stirrer, thus evaporating the ethanol off. After that, a vehicle having a viscosity of approximately 3000 mPas was added as an organic binder. A mixture of ethyl cellulose and terpineol was used as the vehicle. Here, the wt % of the oxide contained in the paste was adjusted to a prescribed oxide wt %, that is 10, 20, 30 or 50 wt %. In this way, pastes each comprising a mixture of the oxide and the organic binder was obtained. Next, each paste was printed onto an alumina substrate by screen printing. After the printing, drying was carried out at 150° C. After that, screen printing was again carried out over the previously printed site, and then drying was again carried out. This was repeated a further two times, so that printing was carried out four times in total.

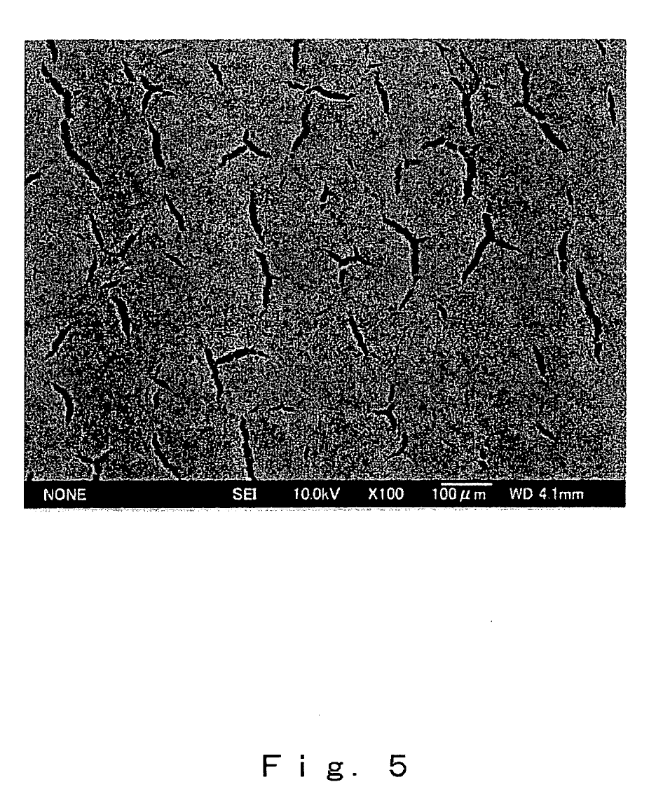

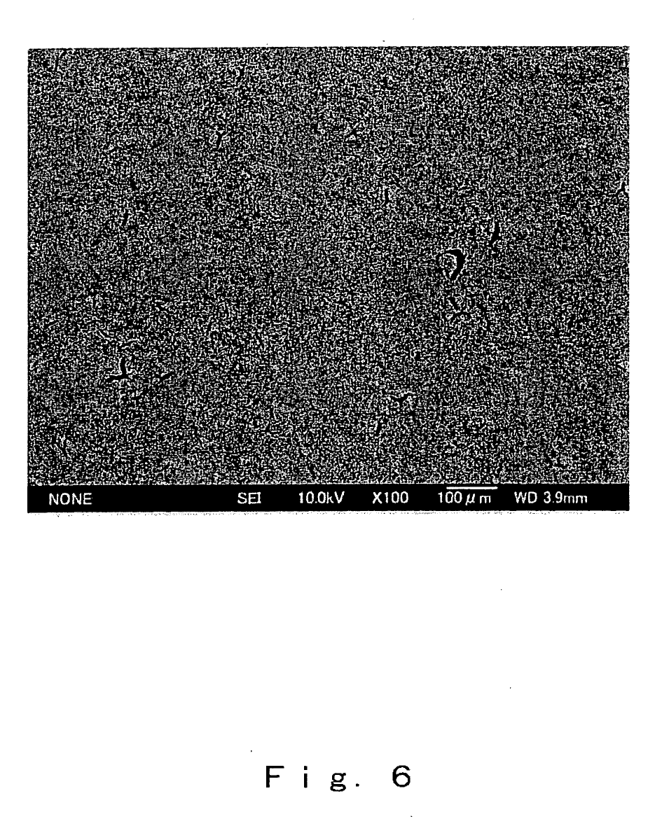

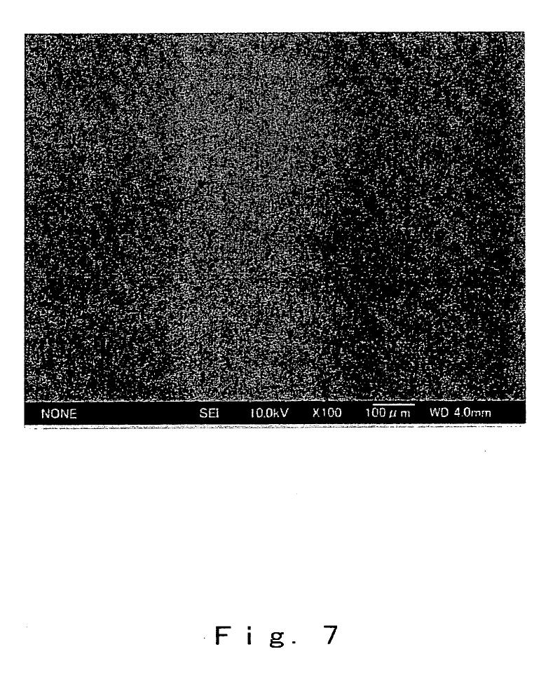

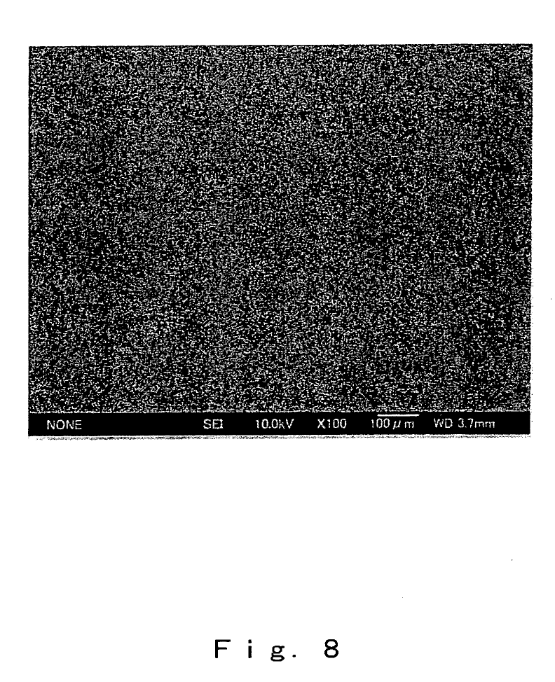

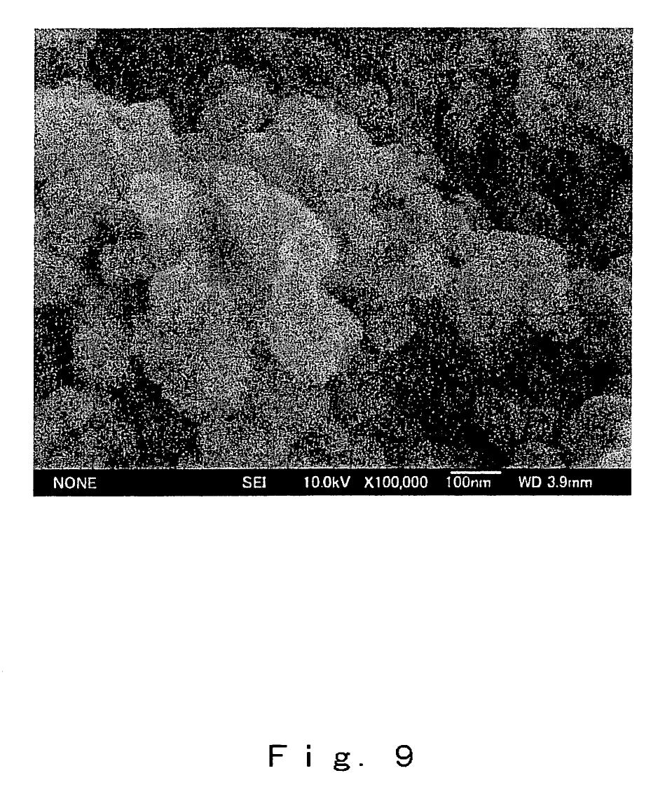

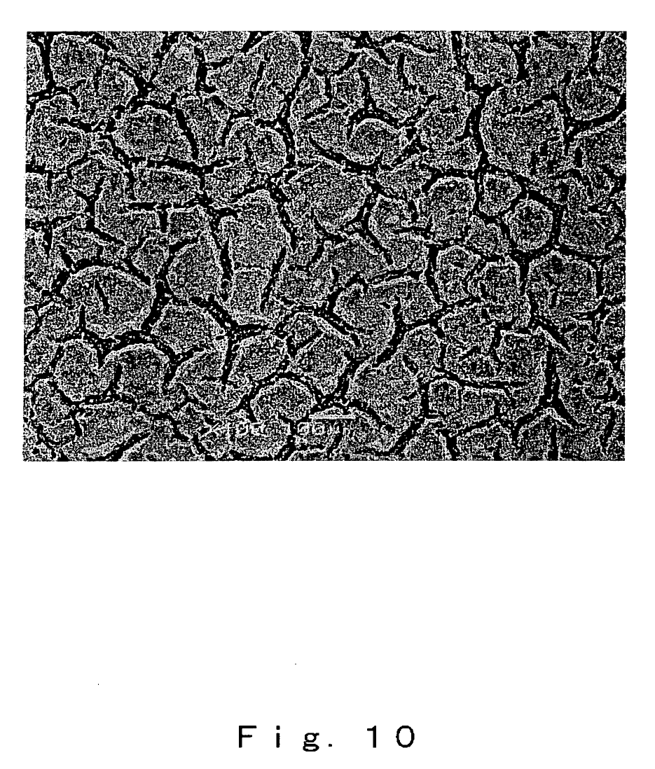

After that, the printed article was calcined for 5 hours at 500° C. in air, and was then sintered for 2 hours at 1050° C. in air, thus obtaining a thick film as an oxygen partial pressure detecting part. SEM photomicrographs of the thick films obtained in this way are shown in FIGS. 5 to 8. FIGS. 5, 6, 7 and 8 show respectively the SEM photomicrographs of the thick films obtained using the pastes having an oxide wt % in the paste of 50, 30, 20 and 10 wt %. FIG. 9 shows an enlargement of FIG. 6. Moreover, as Comparative Example 1, the raw material powder used in Example 1 was put into the vehicle (organic binder) without being dispersed first, and mixing was carried out to obtain a paste, the paste was printed, calcination was carried out for 5 hours at 500° C. in air, and then sintering was carried out for 2 hours at 1100 or 1000° C. in air. FIG. 10 shows the thick film obtained by sintering at 1100° C.

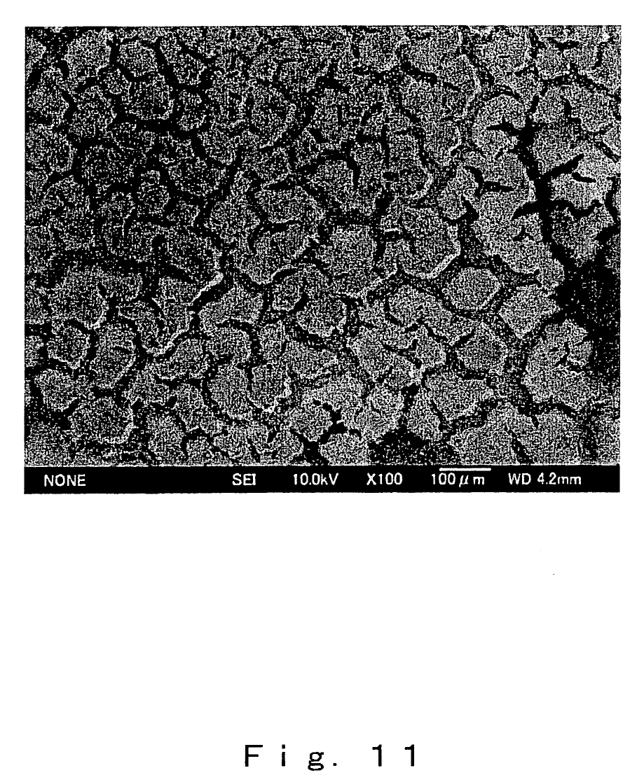

Furthermore, as Comparative Example 2, thick films were manufactured from the raw material powder used in Example 1 by not carrying out the heat treatment step but then carrying out the steps from the step of mixing with ethanol onwards under the same conditions as in Example 1. Pastes having an oxide wt % of 10, 30 or 50 wt % were used. FIG. 11 shows an SEM photomicrograph of the thick film with an oxide wt % in the paste of 30wt %. For the thick films of Comparative Example 1, regardless of whether the sintering was carried out at a temperature of 1100° C. or 1000° C., there were many cracks as shown in FIG. 10. Moreover, the surface was rough, and what appeared to be lumps of still agglomerated particles were observed. It was thus found that with a paste manufactured merely be mixing as in Comparative Example 1, in the case that sintering is carried out at 1000 to 1100° C., many cracks arise. Moreover, for the thick films of Comparative Example 2, regardless of the oxide wt %, many cracks arose as shown in FIG. 11. Moreover, the porous thick film readily peeled away from the substrate. This means that there would be no durability when using as a sensor.

On the other hand, with the thick films of Example 1, compared with Comparative Examples 1 and 2, there were few cracks, and in particular there were extremely few cracks with an oxide wt % of 10 to 30 wt %. Furthermore, at 20 wt %, a porous thick film with no cracks was obtained. Moreover, as shown in FIG. 9, the thick film was extremely porous. Moreover, the average particle diameter was 90 nm. A resistive oxygen sensor having the porous thick film shown in FIGS. 6 and 9 as an oxygen partial pressure detecting part was manufactured. A platinum electrode having a comb shape was formed on the porous thick film by sputtering, a platinum wire was attached thereto, and the resistance of the porous thick film was measured as the sensor output using a two-terminal method. The oxygen sensor was placed in a sample chamber in an electric furnace in which the oxygen partial pressure could be changed, and the resistance of the porous thick film, and the oxygen partial pressure dependence thereof were investigated. Moreover, to investigate the response time, a rapid response evaluation apparatus enabling the oxygen partial pressure to be changed rapidly be changing the total pressure rapidly was used. As sensor property evaluation results, the resistance R and the electrical conductivity σ of the porous thick film at an oxygen partial pressure of 1.0 atm are shown in Table 1. In this way, it was found that a value of from a few tens of kΩ to a few tens of MΩ was exhibited, and there was electrical conductivity. In the case that there were cracks as in Comparative Example 2, there was no electrical conductivity, and use as a sensor was not possible. Moreover, even if there is slight electrical conductivity, because the electrical resistance is high, the circuitry for measuring the resistance and the apparatus becomes complex, which is undesirable. A porous thick film having as few cracks as possible is thus preferable as an oxygen partial pressure detecting part.

TABLE 1

| Temperature (° C.) | R (MΩ) | σ(S/m) |
|---|---|---|
| 600 | 19.7 | 5.0 × 10⁻⁴ |
| 700 | 3.84 | 2.2 × 10−3 |
| 800 | 0.604 | 1.0 × 10−2 |
| 900 | 0.127 | 4.7 × 10−2 |
| 1000 | 0.0307 | 1.8 × 10−1 |

Next, the oxygen partial pressure dependence over an oxygen partial pressure range from 0.010 atm to 1.0 atm is shown in Table 2. n in Table 2 is that in R ∝ p^{1/n}, a small value thereof indicating that the oxygen partial pressure dependence is great. Here, P is the oxygen partial pressure. At 600° C., n was 9.1, and hence the oxygen partial pressure dependence was somewhat low, but at the other temperatures, n was from 5.5 to 6.5. Moreover, the response time (90%) at 800° C. was no more than 20 ms, and hence the response speed was fast, satisfactorily enabling use as an oxygen sensor.

TABLE 2

| Temperature (° C.) | n (R∝P^{1/n}) |
|---|---|
| 600 | 9.1 |
| 700 | 6.5 |
| 800 | 5.6 |
| 900 | 5.5 |
| 1000 | 5.8 |

### EXAMPLE 2

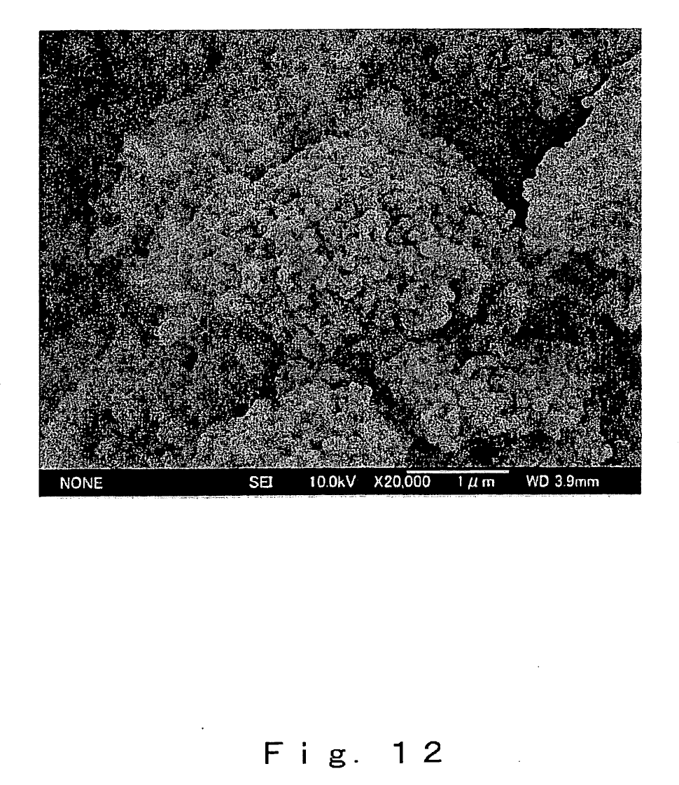

A powder comprising cerium oxide fine particles obtained through a precipitation method was used as a raw material, and the heat treatment temperature in the pretreatment was made to be 950° C.; an SEM photomicrograph of the powder in this case is shown in FIG. 12. Particle growth has occurred to over 100 nm. It was thus found that in the case of manufacturing a thick film for which the average particle diameter of the ultimately obtained thick film is to be 100 nm, a sintering temperature in the pretreatment step of 950° C. is too high.

### EXAMPLE 3

In the present example, a powder was prepared using the following procedure. First, a cerium nitrate aqueous solution was prepared. Next, ammonia water was added, whereby a precipitate was produced. This precipitate was mixed with carbon, and heated for 4 hours at 900° in air, thus obtaining the powder. In this heat treatment step, the heat treatment step for changing the precipitate containing the hydroxide, water and soon into the oxide and the heat treatment step for effecting particle growth were carried out consecutively. The powder was then mixed with ethanol, and then a thick film was manufactured using the same method as in Example 1. The wt % of the oxide contained in the paste was made to be 20 wt %. The porous thick film manufactured in this way contained hardly any cracks, and hence it was found even if the heat treatment step for changing the precipitate containing the hydroxide, water and so on into the oxide and the heat treatment step for effecting particle growth are carried out consecutively, the same effects are obtained.

### EXAMPLE 4

A cerium nitrate aqueous solution and a zirconium oxynitrate aqueous solution were mixed together in a Ce:Zr ratio of 8:2, thus obtaining a mixed aqueous solution. Ammonia water was added to this mixed aqueous solution, thus bringing about coprecipitatation. Next, the precipitate was mixed with carbon, and heated for 4 hours at 900° C. in air, whereby heat treatment for changing the precipitate containing a hydroxide, water and so on into an oxide, and the heat treatment step for effecting particle growth were carried out consecutively. In this way, a powder of cerium oxide containing 20mol % of zirconium oxide was obtained. This was mixed with ethanol, and then thick films were manufactured using the same method as in Example 1. The wt % of the oxide contained in the paste was made to be 10 or 20 wt %. The cerium oxide porous thick films containing 10 mol % of zirconium oxide manufactured in this way were checked using SEM photomicrography, whereupon it was found that hardly any cracks were contained; even at 20 mol %, it was found that there were few cracks, and hence it was found that the present invention can also be applied to cerium oxide containing zirconium oxide.

### INDUSTRIAL APPLICABILITY

As described in detail above, the present invention relates to a method of manufacturing a porous thick film as an oxygen partial pressure detecting part of a resistive oxygen sensor. According to the present invention, the following remarkable effects are produced: 1) taking as a raw material a powder comprising fine particles of cerium oxide or an oxide having cerium oxide as a principal component thereof manufactured using a precipitation method enabling mass production, there can be manufactured a porous thick film of cerium oxide or an oxide having cerium oxide as a principal component thereof that has extremely few cracks, has an average particle diameter of not more than 200 nm, and can be satisfactorily used as an oxygen partial pressure detecting part of an oxygen sensor; 2) with a conventional method, in the case of using as a raw material a powder comprising fine particles that have a low particle diameter (less than 40 nm) and thus readily agglomerate, a porous thick film having few cracks could not be manufactured, but according to the method of the present invention, a porous thick film having few cracks can be manufactured even if such a raw material is used; 3) because the average particle diameter of the porous thick film obtained using the manufacturing method of the present invention is not more than 200 nm, a resistive oxygen sensor having an excellent response speed can be obtained.

What is claimed is:

1. A method of manufacturing a porous thick film as an oxygen partial pressure detecting part of a resistive oxygen sensor comprising taking a fine particle powder of an oxide containing cerium oxide as a raw material powder, preparing a paste containing the oxide, printing the paste onto a substrate by screen printing, calcining and sintering, the method comprising:
a heat treatment step of carrying out heat treatment to effect particle growth from the average particle diameter of the raw material powder to a particle diameter less than the average particle diameter of the ultimately obtained thick film;
a step of mixing the particle growth-effected powder with a solvent;
a step of dispersing agglomerated particles in the solvent;
a step of removing a precipitate;
a step of evaporating off the solvent; and
a step of mixing the resulting oxide with an organic binder to obtain the paste.

2. The method according to claim 1, wherein the average particle diameter of the porous thick film is not more than 200 nm.

3. The method according to claim 1, wherein the average particle diameter of the particle growth-effected powder obtained through the heat treatment step is at least 45 nm.

4. The method according to claim 1, wherein the average particle diameter of the raw material powder before the heat treatment step is at least 10 nm but less than 45 nm.

5. The method according to claim 1, wherein the raw material powder is subjected to heat treatment at 880° C. to 920° C. in the heat treatment step.

6. The method according to claim 1, wherein the proportion by weight of the oxide in the paste is adjusted to 10 to 30 wt %.

7. The method according to claim 1, wherein the fine particle powder of an oxide containing cerium oxide is a fine particle powder of an oxide containing cerium oxide and zirconium oxide.

8. A cerium oxide-based porous thick film as an oxygen partial pressure detecting part of a resistive oxygen sensor, the porous thick film manufactured using the method according to any of claims 1 through 7, whereby the porous thick film has few cracks, has an average particle diameter of not more than 200 nm, and has an electrical conductivity of at least 10⁻³ S/m at 800° C.
